(19) United States
(12) Patent Application Publication
(10) Pub. No.: US 2026/0270084 A1
(43) Pub. Date: Sep. 10, 2026

(54) Method for delegating processing of at least one data flow associated with a digital communication to an intelligent agent

(71) Applicant: Orange, ISSY-LES-MOULINEAUX (FR)

(72) Inventors: Frédéric FIEAU, Chatillon (FR); Gaël FROMENTOUX, Chatillon (FR)

(21) Appl. No.: 19/556,379

(22) Filed: Mar. 4, 2026

(30) Foreign Application Priority Data
Mar. 7, 2025 (FR) FR2502317

(51) Int. Cl. H04L 9/32

(52) U.S. Cl. CPC H04L 9/3247

(57) ABSTRACT

A method for delegating, to an intelligent agent, a processing of at least one data flow associated with at least one digital communication involving a communicating device. Such a method includes, prior to the processing, establishing, by a delegation control component, a smart contract linking the communicating device and the intelligent agent for the implementation of the delegation. The smart contract includes at least one parameter representative of a clause associated with the delegation.

### CROSS REFERENCE TO RELATED APPLICATIONS

This application claims priority to French Patent Application No. FR2502317, filed March 7, 2025, the entire contents of which are incorporated herein by reference.

### Technical Field

The present disclosure lies in the field of artificial intelligence, and more particularly in that of digital communications assisted by generative artificial intelligence.

### Prior Art

A particularly developed and growing field of application of artificial intelligence is that of intelligent agents, for example conversational agents, in charge of providing assistance in the processing of data flows associated with varied digital communications. Such digital communications are not limited to interactions between a human and an intelligent agent, but also include agent-to-agent communications, software entities without artificial intelligence to agent, etc.

In this context where intelligent agents are more and more numerous and improved, an increasingly pronounced degree of specialization of some of these agents is also observed. Thus, a particular request submitted in the context of a digital communication is likely to find a more appropriate response depending on whether it is processed by one intelligent agent rather than another, depending on the domain and/or application to which the digital communication relates, for example. Some intelligent agents are also able to process some requests faster than others, or in larger volumes.

The importance will consequently be understood of developing delegation mechanisms, making it possible to direct the processing of data flows associated with a digital communication to an intelligent agent identified as well suited to process them effectively and satisfactorily, or according to any other criterion of interest for the delegator.

However, existing delegation systems are still rudimentary and have many limitations. More particularly, they do not make it possible to establish, in particular dynamically, a delegation of responsibility from a legal entity (for example from a human user, an administrator, a company) to an intelligent agent. They also do not offer mechanisms for certifying the delegation, for example with regard to its compliance with various criteria of form and/or substance, nor simple means of breaking a delegation if these criteria are not or no longer met. Moreover, existing delegation systems do not make it possible to take into account a dynamic change in the conditions of delegation and uses, while at the same time the supplier of an intelligent agent is generally constantly subject to changing technical and regulatory conditions.

There is therefore a need for a solution that not only makes it possible to define a framework when establishing a delegation of processing of data flows associated with digital communications to an intelligent agent, but also provides various actors with means to ensure compliance with this framework.

### SUMMARY

An exemplary aspect of the present disclosure proposes a solution for overcoming certain drawbacks of the prior art. According to one aspect, the present disclosure relates in fact to a method for delegating, to an intelligent agent, a processing of at least one data flow associated with at least one digital communication involving a communicating device. Such a method comprises, prior to said processing, establishing, by a delegation control component, a smart contract linking said communicating device and said intelligent agent for the implementation of said delegation, said smart contract comprising at least one parameter representing a clause associated with said delegation.

In this way, the delegation of the processing of data flows associated with digital communications is governed by a smart contract, i.e. by at least one computer protocol configured to continuously, automatically and dynamically satisfy a set of conditions under which the delegation must be carried out. Thus, there are mechanisms for characterizing, i.e. making tangible, in particular from a legal and technical point of view, a delegation of responsibility from an entity to an intelligent agent. Furthermore, through the establishment of such a smart contract, the consideration of any desired or necessary changes to the terms of the delegation – for example due to a change in regulations – is facilitated and can be implemented dynamically, and compliance of the delegation with various formal and substantive criteria can be established at any time. Thus, the method allows a communicating device, such as a terminal of the mobile type for example, a router, or an application server, to be able to have one or more processing operations performed by one or more intelligent agents, and consequently to be able to enrich the processing capabilities of the communicating device without resorting to additional capabilities or means on the communicating device. The establishment of the smart contract ensures that the processing of flow data will be carried out in accordance with the clauses of the contract, in particular in terms of quality of service, security and protocol compliance. The intelligent agent can be administered by the same or a separate manager of the communicating device and of the delegation control component.

In a particular embodiment, said at least one parameter representing a clause associated with said delegation belongs to the group of parameters comprising:

information representing a validity period of said delegation;

at least one piece of information associated with said communicating device;

at least one piece of information associated with said intelligent agent;

at least one domain associated with said delegation;

information representing a level of rights associated with said delegation;

at least one type of data authorized in the context of the processing of said at least one data flow associated with said digital communication;

at least one type of interface authorized in the context of processing said at least one data flow associated with said digital communication;

a maximum number of processing requests that can be delegated to said intelligent agent over a given unit of time;

information representative of a maximum total cost associated with said delegation;

information representative of an authorization or prohibition of sub-delegation;

an authorized sub-delegation depth level.

In this way, the framework to be respected for the implementation of a processing delegation according to the present technique can be defined in detail and take into account a wide variety of aspects, including in particular conditions on certain expected characteristics of the delegating communicating device, the delegating intelligent agent, conditions on the nature and modalities of processing of data flows (associated technical domain, type of data to be processed in the context of the delegation, authorized interfaces, sub-delegation permission, quality of service required, security level, protocol required for processing, etc.), the conditions for stopping the delegation when certain thresholds are reached (e.g. a maximum number of requests that can be delegated, an upper limit of a predetermined cost function, etc.). The incorporation of these conditions in the form of clauses of a smart contract also facilitates their subsequent management (development, control by various actors, revocation, etc.).

In a particular embodiment, said establishment of the smart contract comprises:

receiving, from said communicating device, a request to establish a processing delegation, said request comprising at least one parameter representative of a desired (or target) extent of delegation;

transmitting, to said intelligent agent, said request to establish a delegation of processing;

receiving, coming from said intelligent agent, a response to said request to establish a delegation of processing;

generating said smart contract based on at least one of said at least one parameter representative of a desired extent of delegation, when said response is positive.

In this way, the delegation control component is responsible for relaying a delegation request to an intelligent agent capable of accepting to become a delegatee of a communicating device, for collecting the response of this intelligent agent, and, where applicable, for establishing a smart contract linking these two entities, in the event of an agreement on an extent of delegation accepted by these two parties.

In a particular embodiment, said intelligent agent is previously selected from a plurality of candidate intelligent agents, according to said at least one parameter representative of a desired extent of delegation.

In this way, the intelligent agent requested to act as a delegatee in response to a particular delegation request is selected from a set of available intelligent agents, based for example on knowledge of its ability or effectiveness to process data flows in accordance with all or some of the criteria desired by the delegating communicating device for the implementation of such a delegation. This makes it possible to be able to use “expert” intelligent agents for certain processing operations and to be able to update an architecture to enrich and develop processing operations without resorting to modifications to the communicating devices.

In a particular embodiment, said response takes the form of a confirmation that said delegation is achievable by said intelligent agent on at least a part of said desired extent of delegation, referred to as applicable extent of delegation, and said response comprises at least one parameter representative of said applicable extent of delegation.

In this way, the intelligent agent can indicate to the delegation control component the extent to which it is able to implement the delegation. More particularly, an intelligent agent may in particular propose an implementation of the delegation over an area more restricted than that initially desired by the communicating device, but which may nevertheless be of interest for this communicating device, in particular if no intelligent agent has been identified as being able to implement the delegation over the entire desired extent of delegation. By way of example and in a non-exhaustive manner, the intelligent agent may propose a reduced level of security or a less efficient encoding performance for processing the data flow for reasons of capacities of the agent or speed of processing of the flow by the agent.

In a particular embodiment, said establishment of the smart contract further comprises, prior to said generation of said smart contract, when said applicable extent of delegation is different from said desired extent of delegation:

transmitting, to said communicating device, a request for confirmation of establishment of a delegation of processing on said applicable extent of delegation, said request for confirmation comprising said at least one parameter representative of the applicable extent of delegation;

receiving, coming from said communicating device, a response to said request for confirmation of establishment of a delegation of processing on said applicable extent of delegation.

In this way, a proposal, by an intelligent agent, to implement a delegation within a more restricted area or one different from that initially requested, is relayed to the communicating device so that it is able to validate or refuse that the delegation is carried out under these conditions. Thus, a negotiation mechanism is established under the aegis of the delegation control component, in order to allow the communicating device and the requested intelligent agent to converge towards an extent of delegation acceptable to these two parties.

In a particular embodiment, said contract is generated on the basis of said at least one parameter representative of the applicable extent of delegation.

In this way, the smart contract that links the delegating communicating device and the delegated intelligent agent for the implementation of a delegation is established on the basis of the parameters negotiated between these two entities.

In a particular embodiment, said at least one parameter representative of a desired extent of delegation and said at least one parameter representative of an applicable extent of delegation belong to said group of parameters.

In this way, the parameters representative of the desired or applicable extent of delegations can be easily transposed into clauses of a smart contract linking the delegating communicating device and the delegated intelligent agent for the implementation of the delegation.

In a particular embodiment, said establishment of the smart contract further comprises obtaining at least one digital certificate from a digital certificate associated with said intelligent agent and a digital certificate associated with said communicating device, and associating said at least one digital certificate with said smart contract.

In this way, digital certificates are available for identifying and proving the authenticity of the entities present during the effective operations of delegating processing of data flows associated with digital communications, and associated with the smart contract established to govern said delegation, for example as clauses of this contract.

In a particular embodiment, at least one of said at least one digital certificate is generated by an external certification authority, upon request from said delegation control component.

In this way, certification associated with a strong presumption of security and trust – since it is issued by an external certification authority – is available and can be used in particular for delegation levels considered to be critical or important.

In a particular embodiment, at least one of said at least one digital certificate is a delegated certificate generated by an entity among said communicating device and said intelligent agent for the other entity among said communicating device and said intelligent agent.

In this way, lightweight and uncomplicated certification solutions are available to be used insofar as they do not involve external certification authorities, and are therefore adapted, for example, for delegation levels considered to be less critical or less important.

In a particular embodiment, said delegation method further comprises, at the level of said delegation control component, subsequent to the establishment of said smart contract:

obtaining at least one data flow associated with a digital communication initially associated with said communicating device, referred to as current digital communication;

transmitting, to said intelligent agent, said at least one data flow associated with said current digital communication, for processing said at least one data flow associated with said current digital communication within the framework of said delegation;

receiving, coming from said intelligent agent, at least one processed data item associated with said at least one data flow associated with said current digital communication;

checking compliance of processing of said at least one data flow associated with said current digital communication, according to said at least one parameter representative of a clause associated with said delegation.

In this way, the compliance of the manner in which a data flow is processed by a delegated intelligent agent in the context of a delegation operated according to the present technique is checked systematically or at least regularly at the level of the delegation control component. Such checking may be implemented at the initiative of the delegation control component, or other legitimate entities for accessing such information. This check ensures that the intelligent agent processes the data flow and checks whether the conditions of the delegation and in particular whether the parameter representative of the delegation clause has been complied with. This check also enables performance and compliance levels to be established for intelligent agents capable of providing delegations of processing.

In a particular embodiment, said delegation method comprises, when said checking demonstrates a lack of compliance of said processing of said at least one data flow associated with the current digital communication, the revocation of said smart contract.

In this way, the delegation can be terminated automatically when clauses of the smart contract are not complied with, in particular by the delegating communicating device or by the delegated intelligent agent.

In a particular embodiment, said delegation method comprises:

obtaining at least one data item representative of a total cost associated with said delegation of processing;

when said total cost is greater than a certain threshold, revoking said smart contract, and transmitting, to said communicating device and/or to said intelligent agent, a message indicating the end of said delegation of processing.

In this way, conditions for ending the delegation may have been provided for as an aside to the smart contract, which make it possible to end the delegation process when a maximum authorized cost threshold for all the delegation operations carried out is reached or exceeded.

According to another aspect, the present technique relates to a component for controlling a delegation, to an intelligent agent, of processing of at least one data flow associated with at least one digital communication involving a communicating device. This component comprises at least one processor configured to, prior to said processing, establish a smart contract linking said communicating device and said intelligent agent for the implementation of said delegation, said smart contract comprising at least one parameter representative of a clause associated with said delegation.

Such a component for controlling a delegation can of course have the various characteristics relating to the delegation method according to aspects of the present disclosure, which can be combined or considered individually. Thus, the features and advantages of this device are the same as those of the method for delegating, to an intelligent agent, a processing of at least one data flow associated with at least one digital communication involving a communicating device, and are not detailed further.

According to another aspect, the present disclosure also relates to a computer program product downloadable from a communication network and/or stored on a computer-readable medium and/or executed by a microprocessor, comprising program code instructions for executing at least one method as described above in any one of its embodiments, when this method is executed on a computer.

The present disclosure also relates to a computer-readable storage medium on which a computer program is recorded comprising program code instructions for executing the steps of a method as previously described, in any one of their embodiments.

Such a recording medium may be any entity or device capable of storing the program. For example, the medium can include a storage means, such as a ROM, for example a CD-ROM or a ROM of a microelectronics circuit, or also a magnetic storage means, for example a flash drive or a hard drive.

Besides, such a storage medium may be a transmissible medium such as an electrical or optical signal, which can be conveyed via an electrical or optical cable, by radio or by other means, so that the computer program contained therein is remotely executable. In particular, the program according to an aspect of the present disclosure may be downloaded on a network, for example the Internet.

The different embodiments mentioned above can be combined together for the implementation of one or more aspects of the present disclosure.

### FIGURES

Other features and advantages of one or more aspects of the present disclosure will appear more clearly upon reading the following description of a particular embodiment, given as a mere illustrative and non-limiting example, and from the appended drawings, wherein:

FIG. 1 schematically illustrates an example environment for the implementation of the present technique, in a particular embodiment;

FIG. 2 schematically illustrates, in the form of a sequence diagram, the steps of a delegation method in a particular embodiment of the proposed technique;

FIG. 3 describes a simplified architecture of a delegation control component, in a particular embodiment of the proposed technique.

### DETAILED DESCRIPTION

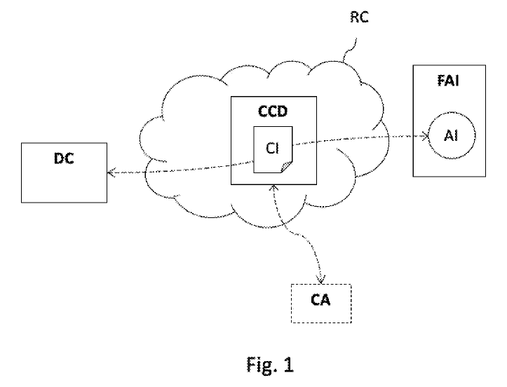

An example of an environment in which the present technique is implemented, in a particular embodiment, is described in relation to FIG. 1. A communicating device DC is capable of being used within the scope of processing at least one digital communication. Such a communicating device DC may for example take the form of a communication terminal (a smart phone, a digital tablet, a computer, etc.), a connected object, a residential gateway, a server, or more generally any software instance capable of establishing or receiving digital communications. In this context, according to a first aspect, a method is proposed for delegating, to an intelligent agent AI accessible via a communication network RC, processing of at least one data flow associated with at least one digital communication involving the communicating device DC. The use of such an intelligent agent AI, made available by a service provider FAI, may have various reasons, for example to reduce the load of the communicating device DC, or even to benefit from more appropriate processing of the data flows associated with a digital communication by using a specialized intelligent agent. Within the scope of the present technique, the processing operations and data flows subject to delegation may be of very varied types. The delegated processing operations may for example comprise, by way of purely illustrative and non-limiting purposes, operations for routing a data flow, enriching a data flow, filtering a data flow, encrypting or decrypting a data flow, extracting data from a data flow, etc. In the field of the management of communication networks, the data flows to which the delegation of processing relates may for example comprise control data flows (i.e. of a control plan) making it possible to manage the way in which useful data associated with a digital communication (e.g. data from the data plan) are routed over the network. Alternatively or additionally, data flows of a data plan may also be subject to a delegation of processing according to the present technique.

According to the general principle of the proposed technique, the delegation method comprises, prior to the implementation of such processing operations, establishing, by a delegation control component CCD, a smart contract CI linking the communicating device DC and the intelligent agent AI for the implementation of the delegation operations. “Smart contract” means a set of autonomous programs that automatically execute the terms and conditions of a contract, without requiring human intervention. In other words, a smart contract is a compiled computer program that carries a set of features enabling it to automatically and autonomously execute at least some of the specific clauses of the contract it carries. In this way, before any effective delegation of the processing of at least one data flow associated with a digital communication, a framework is set to define under which conditions such a delegation must be carried out.

For this purpose, the smart contract CI comprises at least one parameter representative of a clause associated with said delegation. For purely illustrative and non-limiting purposes, the following are examples of parameters representative of clauses that may be associated with a delegation, and which represent as many conditions to be met for a delegation to be considered valid or compliant. Such parameters comprise, for example:

information representative of a time of validity of the delegation, for example in the form of a duration or an expiry date;

at least one piece of information associated with the communicating device DC, in other words information on expected characteristics concerning the delegator, for example its location in the network, its type, an associated identifier, etc.;

at least one piece of information associated with the intelligent agent AI, in other words information on expected characteristics concerning the delegatee, for example its location in the network, its type, an associated identifier, etc.;

at least one technical or functional area associated with the delegation (e.g. finance, mobility, trade, studies, sport, etc.);

information representative of a level of rights associated with the delegation, for example data specifying whether the delegated intelligent agent AI is only limited to providing information, or whether it is authorized to access certain systems and/or databases in writing to perform an update of information;

at least one type of data authorized in the context of the processing of data flows associated with the digital communication, for example a type of media (text, video, image, particular file, etc.) that can be exchanged;

at least one type of interface (audio input, camera, various sensors) the use of which is authorized in the context of processing data flows associated with the digital communication;

a maximum number of delegatable processing requests to the intelligent agent over a given unit of time, for example a maximum number of delegatable requests per second, per minute, per hour, per day, or over the entire duration of delegation;

information representative of a maximum total cost associated with the delegation process as a whole, making it possible, for example, to end the delegation when this cost is reached or exceeded;

information representative of an authorization or prohibition of sub-delegation, in other words information specifying whether an intelligent agent to which the processing of data flows associated with a digital communication is delegated is itself authorized to sub-delegate this processing to another intelligent agent;

an authorized sub-delegation depth level, for example a number of sub-delegations authorized for processing the same data flow associated with a digital communication.

The above list is not exhaustive, and other parameters may serve as clauses of the smart contract linking the communicating device DC and an intelligent agent AI for the implementation of a delegation between these two entities.

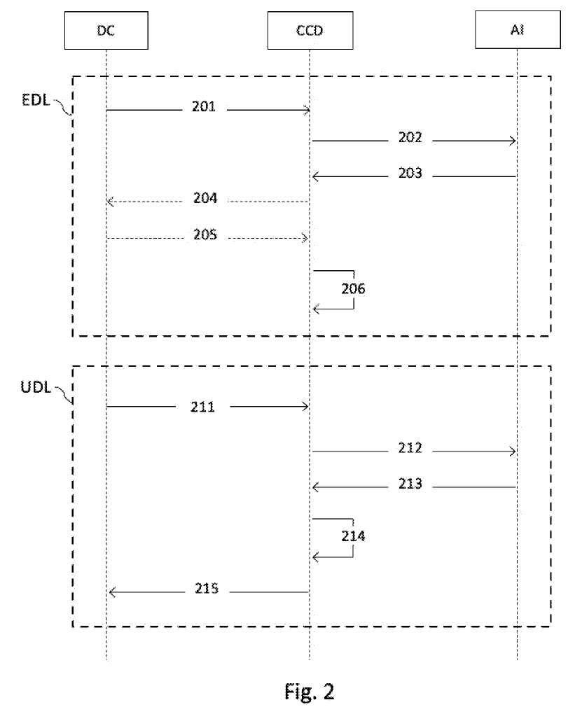

FIG. 2 presents in detail the steps of establishing EDL such a smart contract CI by the delegation control component CCD, in a particular embodiment.

In a step 201, the delegation control component CCD receives, from the communicating device DC, a request to establish a delegation of processing, comprising at least one parameter representative of an extent of delegation desired (or targeted) by the communicating device DC. The parameters representative of a desired extent of delegation are, for example, of the same type as those previously described with reference to possible clauses of a smart contract. By this request for delegation, the communicating device DC can thus express its wish to delegate the processing of data flows associated with digital communications and specify the conditions under which such a delegation must be carried out. The communicating device DC can thus indicate that the digital communications for which it wishes to delegate the processing of associated data flows are those relating to a particular domain, a particular interface or a particular medium, or specify a desired delegation period, a given volume of requests to be processed, etc.

In a step 202, the delegation control component CCD relays this delegation request to an intelligent agent AI. Such an intelligent agent may have been previously referenced within the delegation control component CCD. According to a particular feature, the intelligent agent is for example selected from a plurality of candidate intelligent agents previously referenced within the delegation control component CCD, according to the parameter(s) representative of the desired extent of delegation (and possibly taking into account other criteria set for example by the delegation control component). Thus, for example, the intelligent agent most capable of correctly and efficiently processing data flows associated with digital communications on the desired extent of delegation is selected.

In a step 203, the delegation control component CCD receives, coming from the intelligent agent AI to which the delegation request was transmitted in step 202, a response to this request, which may be positive or negative. For reasons specific to it, for example when it determines that it is not able to carry out a delegation of processing to the extent requested by the communicating device DC, the intelligent agent may reject the delegation request. Conversely, in the event of acceptance by the intelligent agent AI to be a delegatee for the processing of data flows associated with digital communications involving the communicating device DC, the response received by the delegation control component CCD in step 203 takes the form of, for example, a confirmation that the delegation is achievable by the intelligent agent AI on at least a part of the desired extent of delegation, referred to as the applicable extent of delegation. In the event that the applicable extent of delegation does not exactly match the desired extent of delegation, the delegation confirmation received in step 203 comprises at least one parameter representative of this applicable extent of delegation. In this case, a new exchange of information is possibly carried out between the delegation control component CCD and the communicating device DC, in order to ensure that the communicating device DC maintains its delegation request over the applicable extent of delegation, potentially more restricted than the one initially desired.

Thus, in the context of such an exchange, the delegation control component CCD transmits, for example, to the communicating device DC, in a step 204, a request for confirmation of establishing a delegation of processing on the applicable extent of delegation. This confirmation request comprises the parameter(s) representative of the applicable extent of delegation received in step 203. Upon receipt of this request, the communicating device DC evaluates the extent to which the implementation of the delegation over the applicable extent of delegation, in other words over the extent of delegation proposed by the intelligent agent AI, is acceptable. Such an evaluation may for example take into account a proportion of common parameters (or common conditions) indicated as verifiable by the intelligent agent AI, with regard to a comparison between the desired extent of delegation and the applicable extent of delegation (in other words, the evaluation then takes into account a degree of proximity or overlap between the applicable extent of delegation and the desired extent of delegation). Such an evaluation may also, alternatively or additionally, be based on a pre-established hierarchy of importance associated with certain parameters representative of a extent of delegation (the applicable extent of delegation being then, for example, all the more acceptable for the device communicating DC as particular parameters considered as priority by this device are indicated as verifiable by the intelligent agent AI, i.e. comprised in the applicable extent of delegation).

In a step 205, the delegation control component CCD receives, coming from the communicating device DC, a response to the request for confirmation of establishing a processing delegation on said applicable extent of delegation. Such a response may take the form of an acceptance of the implementation of the delegation over the applicable extent of delegation, a rejection of the implementation of the delegation over the applicable extent of delegation, or possibly a request for delegation over a modified desired extent of delegation different from the applicable extent of delegation and the initially desired extent of delegation (step 205 then having, for example, characteristics similar to those of step 201 described previously).

Within the scope of this process, which may resemble a negotiation process, several exchanges of information between the delegation control component CCD and the communicating device DC on the one hand, and between the delegation control component CCD and the intelligent agent AI on the other hand, may be implemented where applicable, until a extent of delegation accepted by all (delegation control component CCD, communicating device DC and intelligent agent AI) is identified.

In a step 206, once the communicating device DC and the intelligent agent AI have agreed on the applicable extent of delegation, the delegation control component CCD generates the smart contract that binds these two entities (communicating device DC and intelligent agent AI) for the implementation of the delegation of processing. More particularly, the parameters representative of the applicable extent of delegation are translated into parameters representative of clauses of the smart contract CI, associated with said delegation.

In a particular embodiment, the establishment of the smart contract also comprises obtaining one or more digital certificates, which may in particular comprise at least one digital certificate associated with the intelligent agent AI and/or at least one digital certificate associated with the communicating device DC. According to a particular feature, such digital certificates – which subsequently make it possible, for example, to ensure the identity of the entities present during the effective operations of delegating processing of digital communications – are associated with the smart contract CI, for example as clauses of this contract. The generation of these digital certificates can be implemented by various means.

In a particular embodiment, according to a first implementation, at least one of these digital certificates is generated by an external certification authority (for example the certification authority referenced CA in FIG. 1), upon request in this regard from the delegation control component CCD. An automatic short-term certificate management protocol, of the ACME-STAR type (ACME referring to “Automated Certificate Management Environment”, and STAR to the “Support for Short-Term, Automatically-Renewed ” extension of this protocol), for example, may be used in this context, enabling the delegation control component CCD to request from the external certification authority CA the establishment of a time-limited digital certificate for the communicating device DC and/or the intelligent agent AI, which they can retrieve directly from that authority once these certificates have been generated.

Alternatively or additionally, according to a second implementation, at least one of these digital certificates is a delegated certificate generated by one party among said communicating device and said intelligent agent for the other party among said communicating device and said intelligent agent, according to techniques known as "delegated credentials".

The choice between one or the other of the two implementations described above may in particular be made according to a compromise aimed at between security and simplicity of implementation. Thus, the use of the ACME-STAR method, which is more secure insofar as it involves an external certification authority, may for example be preferred for first-level delegations, i.e. delegations directly established between the communicating device and a first intelligent agent. The use of the other method based on delegated certificates, which is simpler to implement insofar as it does not involve third-party entities (in particular no external certification authority), may be reserved for delegations at deeper levels, in other words sub-delegations that may be authorized and implemented by an intelligent agent already delegated to a communicating device or another intelligent agent, and which itself wishes to sub-delegate to other intelligent agents the processing of certain digital communications entrusted to it directly or indirectly.

Once the smart contract CI is established between the communicating device DC and the intelligent agent AI, this agent can be requested to process data flows associated with the delegated digital communications. Such a delegation use phase UDL, which follows the initial delegation establishment phase EDL via the generation of a smart contract, is also illustrated in FIG. 2, in a particular embodiment.

In a step 211, the delegation control component CCD obtains at least one data flow associated with a digital communication initially associated with the communicating device DC, referred to as current digital communication. Such a data flow corresponds for example to a data flow received by the communicating device DC coming from a third-party device within the framework of the current digital communication, with a view to processing by the communicating device DC, and which the communicating device DC redirects before processing to the delegation control component CCD for implementing the delegation (the case of step 211 illustrated in FIG. 2) with a view to processing by the intelligent agent AI. Alternatively (not illustrated in FIG. 2), such a data flow sent by a third-party device to the communicating device DC for processing may also be intercepted by the delegation control component CCD before it reaches the communicating device DC for which it was initially intended. According to yet another alternative, the data flow obtained in step 211 may also correspond to a data flow generated at the same level of the communicating device DC in the context of the current digital communication, for example to initiate such communication, and which the communicating device DC relays to the delegation control component CCD with a view to processing delegated to the intelligent agent AI.

In a step 212, the delegation control component CCD transmits the data flow associated with the current digital communication to an intelligent agent responsible for processing it, on the basis of a smart contract pre-established during the delegation establishment phase EDL between the communicating device DC and this intelligent agent AI. The delegation control component receives from said intelligent agent AI, in a step 213, at least one processed data item associated with said current digital communication. Such a processed data item corresponds to the processing of the data flow associated with the current digital communication, carried out by the intelligent agent within the scope of the delegation.

In a step 214, the delegation control component CCD performs a check of compliance, with the smart contract CI, of processing of the data flow associated with the current digital communication. More particularly, such verification is carried out on the basis of the parameters representative of the clauses associated with said delegation. Such a check may be implemented at various times of the delegation use phase, and at the initiative not only of the delegation control component CCD itself but also of other entities (control, regulation, etc.).

In the event of compliance, with the smart contract CI, of the processing of the data flow associated with the current digital communication, the processed data item received in step 213 by the delegation control component CCD may for example be relayed to the communicating device DC, in a step 215, for return to a user.

According to a particular feature, when the verification carried out in step 214 demonstrates, on the other hand, a lack of compliance of the processing of the data flow associated with the current digital communication with the clauses of the smart contract, the clause(s) not complied with or the entire smart contract is automatically revoked.

In a particular embodiment, conditions for ending the delegation may also have been provided for as an aside to the smart contract. Such conditions, implemented at the level of the delegation control component CCD (e.g. at the time of drawing up or establishing the smart contract, possibly upon request by the communicating device DC) comprise for example taking into account a cost function associated with the delegation, and make it possible in particular to end the delegation process when a maximum authorized cost for all the delegation operations carried out is reached or exceeded.

In this context, the delegation control component CCD obtains, for example during each request to the delegated intelligent agent to process a data flow associated with a digital communication, at least one data item representative of a total (or cumulated) cost associated with the delegation of processing. Such a data item is for example received from the communicating device DC, or determined (e.g. calculated) by the delegation control component CCD. According to a particular feature, a total cost associated with the delegation is for example estimated by multiplying a number of tokens used by a fixed unit cost for a token, a use of one or more tokens corresponding to one or more data flow processing operations delegated to the intelligent agent AI (the number of tokens used for a processing operation may in particular depend on the complexity of the delegated processing operation).

The delegation control component then determines whether this total cost is greater than a certain threshold. If not, the delegation mechanism as defined by the smart contract CI remains activated, and the intelligent agent AI may again be used as a delegatee for the processing of data flows associated with digital communications involving the communicating device DC. On the other hand, when the total cost reaches or exceeds the maximum authorized cost threshold, the delegation control component CCD ends the delegation process: it then proceeds, for example, to revoke the smart contract CI, and sends a message to the communicating device DC and/or to the intelligent agent AI indicating the end of the delegation of processing. The intelligent agent AI can then no longer be used for processing data flows as a delegatee of the communicating device DC.

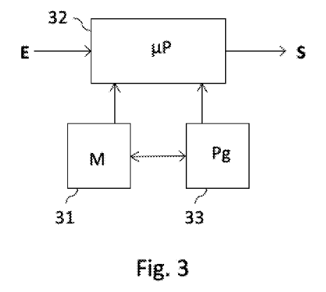

The simplified structure of a delegation control component in one particular embodiment of the proposed technique is now presented in connection with FIG. 3. Such a control component intervenes in the delegation to an intelligent agent of a processing of at least one data flow associated with at least one digital communication involving a communicating device. The delegation control component may be hosted within a standalone device (for example, a server) independent of those hosting the delegated intelligent agents. Alternatively, in another particular embodiment, it may also be integrated directly within a device that also implements one or more intelligent agents that may be requested in the context of a delegation request.

The delegation control component, according to the proposed technique, comprises for example a memory 31 consisting of a buffer memory M, a processing unit 32, equipped for example with a microprocessor µP, and controlled by the computer program Pg 33, implementing steps of the delegation method according to at least one embodiment of the disclosure.

Upon initialization, the code instructions of the computer program 33are loaded into the buffer memory before being executed by the processor of the processing unit 32.

The processing unit 32 receives at input E, for example, a request to establish a delegation of processing of data flows associated with digital communications, coming from a communicating device. Such a request comprises, for example, one or more parameters representative of a desired extent of delegation. The microprocessor of the processing unit 32 then carries out the steps of the delegation method, according to the instructions of the computer program 33. More particularly, the processing unit 32 identifies an intelligent agent capable of acting as a delegatee for the processing of data flows associated with digital communications involving the communicating device, and relays the delegation request to this intelligent agent. The processing unit 32 acts as a negotiation intermediary between the communicating device and the intelligent agent, for determining an applicable extent of delegation for the implementation of a delegation of processing. Once such an extent has been established, the processing unit generates and outputs S at least one smart contract linking the communicating device and the intelligent agent identified for the implementation of said delegation, according to at least one of the embodiments described above.

What is claimed is:

1. A delegation method implemented by a delegation control component of a device and comprising:
controlling delegation, to an intelligent agent, of processing of at least one data flow associated with at least one digital communication involving a communicating device, said controlling comprising:
prior to said processing, establishing, by the delegation control component, a smart contract linking said communicating device and said intelligent agent for implementing said delegating, said smart contract comprising at least one parameter representative of a clause associated with said delegation.

2. The delegation method according to claim 1, wherein said at least one parameter representative of a clause associated with said delegation belongs to the group of parameters consisting of:
information representing a validity period of said delegation;
at least one piece of information associated with said communicating device;
at least one piece of information associated with said intelligent agent;
at least one domain associated with said delegation;
information representing a level of rights associated with said delegation;
at least one type of data authorized in a context of the processing of said at least one data flow associated with said digital communication;
at least one type of interface authorized in a context of processing said at least one data flow associated with said digital communication;
a maximum number of processing requests that can be delegated to said intelligent agent over a given unit of time;
information representative of a maximum total cost associated with said delegation;
information representative of an authorization or prohibition of sub-delegation;
an authorized sub-delegation depth level.

3. The delegation method according to claim 1, wherein said establishment of the smart contract comprises:
receiving, coming from said communicating device, a request to establish a processing delegation, said request comprising at least one parameter representative of a desired extent of delegation;
transmitting, to said intelligent agent, said request to establish a delegation of processing;
receiving, coming from said intelligent agent, a response to said request to establish a delegation of processing; and
generating said smart contract based on at least one of said at least one parameter representative of a desired extent of delegation, when said response is positive.

4. The delegation method according to claim 3, wherein said intelligent agent has been previously selected from a plurality of candidate intelligent agents, according to said at least one parameter representative of a desired extent of delegation.

5. The delegation method according to claim 3, wherein said response takes a form of confirmation that said delegation is achievable by said intelligent agent on at least a part of said desired extent of delegation, referred to as applicable extent of delegation, and said response comprises at least one parameter representative of said applicable extent of delegation.

6. The delegation method according to claim 5, wherein said establishment of the smart contract further comprises, prior to said generation of said smart contract, in response to said applicable extent of delegation being different from said desired extent of delegation:
transmitting, to said communicating device, a request for confirmation of establishing a delegation of processing on said applicable extent of delegation, said request for confirmation comprising said at least one parameter representative of the applicable extent of delegation; and
receiving, coming from said communicating device, a response to said request for confirmation of establishing a delegation of processing on said applicable extent of delegation.

7. The delegation method according to claim 5, wherein said contract is generated based on said at least one parameter representative of the applicable extent of delegation.

8. The delegation method according to claim 5, wherein said at least one parameter representative of a desired extent of delegation and said at least one parameter representative of an applicable extent of delegation belong to said group of parameters.

9. The delegation method according to claim 1, wherein said establishment of the smart contract further comprises obtaining at least one digital certificate among a digital certificate associated with said intelligent agent and a digital certificate associated with said communicating device, and associating said at least one digital certificate with said smart contract.

10. The delegation method according to claim 9, wherein at least one of said at least one digital certificate is generated by an external certification authority, upon request by said delegation control component.

11. The delegation method according to claim 9, wherein at least one of said at least one digital certificate is a delegated certificate generated by an entity among said communicating device and said intelligent agent for the other entity among said communicating device and said intelligent agent.

12. The delegation method according to claim 1, wherein the method comprises, at a level of said delegation control component, subsequent to the establishment of said smart contract:
obtaining at least one data flow associated with a digital communication initially associated with said communicating device, referred to as a current digital communication;
transmitting, to said intelligent agent, said at least one data flow associated with said current digital communication, for processing said at least one data flow associated with said current digital communication within the framework of said delegation;
receiving, coming from said intelligent agent, at least one processed data item associated with said at least one data flow associated with said current digital communication; and
checking compliance of processing of said at least one data flow associated with said current digital communication, according to said at least one parameter representative of a clause associated with said delegation.

13. The delegation method according to claim 12, wherein the method comprises, in response to said verification demonstrating a lack of compliance of said processing of said at least one data flow associated with the current digital communication, revoking said smart contract.

14. The delegation method according to claim 1, wherein the method comprises:
obtaining at least one data item representative of a total cost associated with said delegation of processing;
when said total cost is greater than a certain threshold, revoking said smart contract, and transmitting, to said communicating device and/or to said intelligent agent, a message indicating the end of said delegation of processing.

15. A component for controlling a delegation, to an intelligent agent, of processing of at least one data flow associated with at least one digital communication involving a communicating device, said component comprising:
at least one processor configured to, prior to said processing, establish a smart contract linking said communicating device and said intelligent agent for implementing said delegation, said smart contract comprising at least one parameter representative of a clause associated with said delegation.

16. A non-transitory computer readable medium comprising program code instructions for execution of a method when the instructions are executed by a computer, wherein the method comprises:
controlling delegation, to an intelligent agent, of processing of at least one data flow associated with at least one digital communication involving a communicating device, said controlling comprising:
prior to said processing, establishing a smart contract linking said communicating device and said intelligent agent for implementing said delegating, said smart contract comprising at least one parameter representative of a clause associated with said delegation.
